(19) United States
(12) Patent Application Publication
(10) Pub. No.: US 2007/0131760 A1
(43) Pub. Date: Jun. 14, 2007

(54) Electronically Refunding Change from a Purchase Transaction

(76) Inventor: Asheem Aggarwal, New York, NY (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/548,341

(22) Filed: Oct. 11, 2006

Related U.S. Application Data
(60) Provisional application No. 60/726,284, filed on Oct. 13, 2005.

(51) Int. Cl. G06K 5/00; G06K 15/00; G06Q 20/00

(52) U.S. Cl. 235/380; 235/383; 705/17

(57) ABSTRACT

In a system where a customer makes a purchase with a merchant using currency, methods are provided for enabling the customer to receive change electronically. The customer has a customer identification device that is associated with a change account stored at a change server. The merchant also has a change account associated with a change server. A change settlement occurs between the customer change account and the merchant change account to transfer some or all of the change to the customer change account.

### CROSS-REFERENCE TO RELATED APPLICATIONS

This application claims benefit from and priority to U.S. Provisional Patent Application Ser. No. 60/726,284, filed Oct. 13, 2005, and entitled “ELECTRONIC TRANSFER OF CHANGE FROM PURCHASE TRANSACTIONS,” which application is incorporated by reference herein in its entirety.

### BACKGROUND OF THE INVENTION

1. The Field of the Invention

The present invention relates to systems and methods for facilitating a purchase transaction including refunding change electronically.

2. Background and Related Art

When a customer conducts a purchase using currency, the term “currency” being defined as any physical payment means as opposed to electronic payment means, often, there is an amount of change associated with the purchase. (Physical payment means being, but not limited to, paper bills, checks, money orders, treasury notes, banknotes, coinage, and other forms of cash.) During the purchase transaction, it is often inconvenient to have to wait for the cashier to count the change to return back to the customer, especially if the cashier does not have the exact amount of change immediately on-hand. In addition, when the change is returned to the customer, it is typically a hassle to have to organize the paper bills and coinage in a money carrier, such as a purse or wallet. When a customer is in a hurry, change is thrown loosely into an ad hoc storage device, such as a pocket, a change receptacle in the car or at home, and the like. Because change is typically loosely stored and handled, it can easily be lost or misplaced. Over a period of time, however, the amount of change resulting from purchase transactions can result in a significant amount of money. Thus, it would be desirable to more effectively store and manage change received from purchase transactions.

### BRIEF DESCRIPTION OF THE DRAWINGS

In order to describe the manner in which the features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates an exemplary environment for implementing the present invention and illustrates relationships between customers and merchants in a purchase transaction, according to one embodiment of the present invention;

FIG. 1B illustrates an exemplary data structure for maintaining customer information on a customer identification device, according to one embodiment of the present invention;

FIG. 1C illustrates an exemplary data structure for a change request, according to one embodiment of the present invention; and

FIG. 2 is an exemplary method for facilitating a purchase transaction involving the handling of change, according to one embodiment of the present invention.

### DETAILED DESCRIPTION OF EXEMPLARY EMBODIMENTS

The present invention relates to financial systems that perform electronic transactions that facilitate a purchase transaction involving the refund of change. Methods and systems are provided for allowing customers to receive all or a portion of change due back from a purchase transaction electronically rather than in currency form. The term “change” as used herein, is defined as the difference in the amount presented for payment and the actual purchase amount for one or more items.

The invention is disclosed herein in reference to a financial system that permits a merchant to perform purchase transactions with customers. In some embodiments, the purchase transaction involves returning change to the customer. In these situations, the customer uses a customer identification device to electronically accept change from the merchant. Thus, having to handle loose currency is reduced or eliminated. Further, the electronic change aggregates to form a balance which can be accessed and used by the customer.

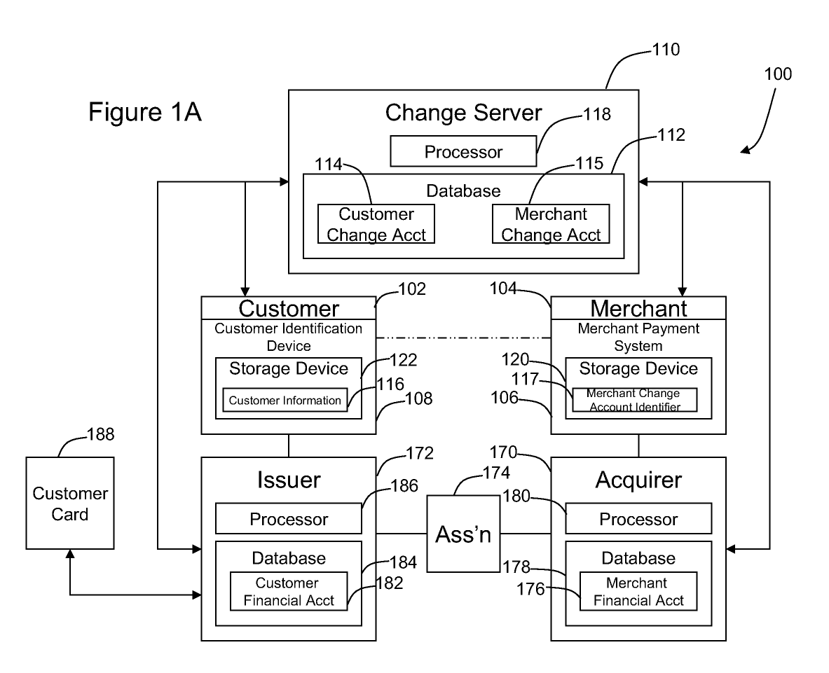

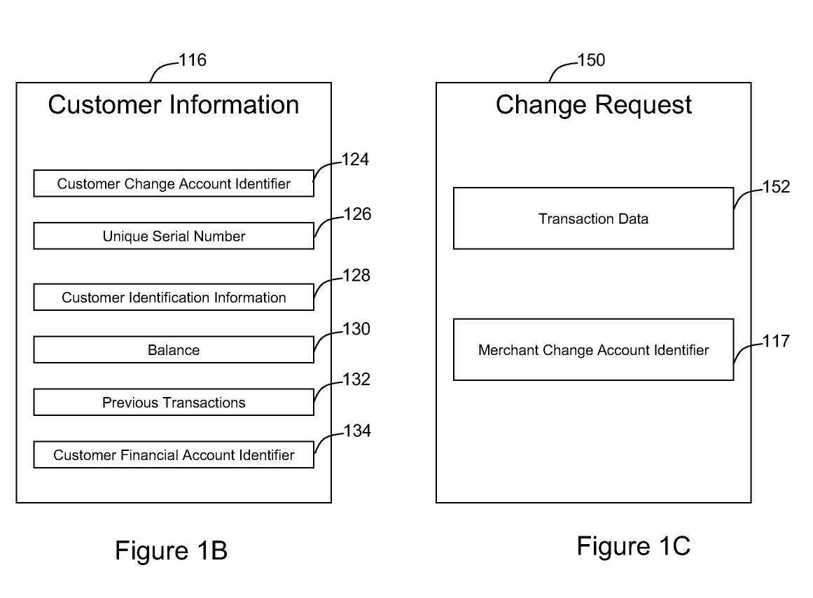

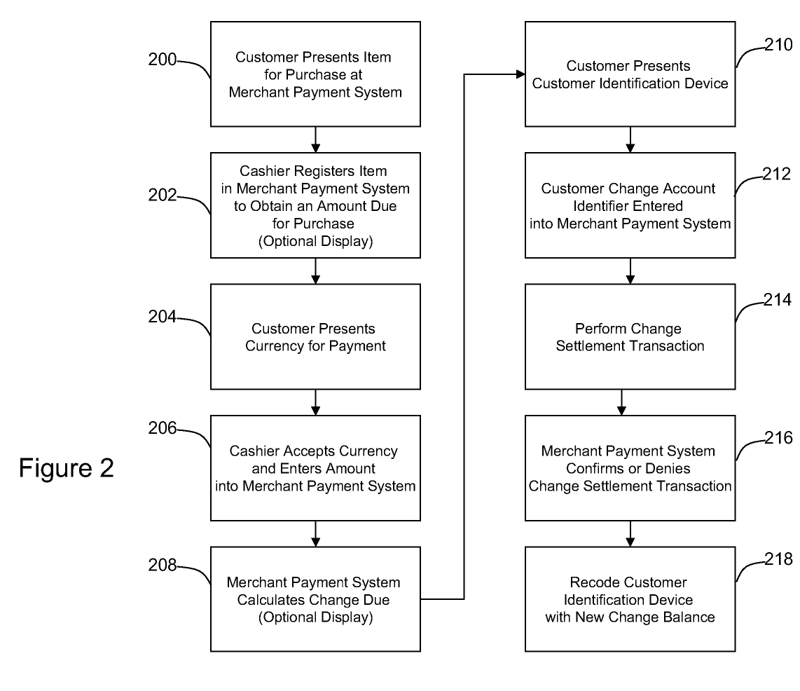

An example of such a financial system is disclosed herein in FIG. 1A-1C while an exemplary method for performing the purchase transactions of the present invention is illustrated in FIG. 2. Although the methods of performing a purchase transaction and electronically returning change to a customer can be performed in the system illustrated in FIG. 1A-1C and the method of FIG. 2, the methods of the invention can also be practiced in any of a number of other financial systems or corresponding methods in which a merchant receives payment or funds from customers or third parties in the form of currency and, conversely, refunds change electronically.

FIG. 1A is a block diagram that illustrates an exemplary financial system 100 involving various entities that may be involved with purchase transactions of the present invention. While various entities are shown, FIG. 1A is used to show various system configurations using the same diagram, so it will be appreciated that not all of the entities shown are required in the payment systems of the present invention.

When a customer 102 presents an item to a merchant 104 for purchase, a merchant payment system 106 typically determines whether the financial transaction requires change to be returned to the customer 102. The customer 102 can receive the change electronically using a customer identification device 108. Thus, both merchant payment system 106 and customer identification device 108 can electronically communicate with a change server 110. Change server 110 includes a database 112 that stores a customer change account 114 and a merchant change account 115. Thus, customer identification device 108 includes customer information 116 identifying the customer change account 114. Similarly, merchant payment system 106 includes a merchant change account identifier 117 corresponding to merchant change account 115. Further, change server 110 can include a processor 118 for handling change transactions. It will be appreciated that the change server 110 can be a single server or multiple distributed servers.

Customer identification device 108 can be any transaction device that facilitates receiving change electronically. Thus, customer identification device 108 can be, but is not limited to, any instrument that is encoded with customer information 116. As shown in FIG. 1B, customer information 116 that can be encoded onto storage device 122 include, but is not limited to, customer change account identifier 124, a unique serial number 126, customer identification information 128 (such as name, address, phone number), balance 130 for customer change account 114, and previous transaction information 132. In addition, other account identifiers 134 may also be included in embodiments where customer identification device 108 can be used for functions other than receiving change refunds. Any or all of this same information could be included in database 112 associated with customer change account 114.

Customer identification device 108 can be a device designed only to electronically receive change. Alternatively, customer identification device 108 can be any device that can be used for financial transactions such as, but not limited to, a financial card (e.g., a credit card, a debit card, a rewards card), a smart card, RFID enabled cards, IR enabled cards, and the like. In addition, the customer identification device 108 can be any device that is able to identify the customer change account identifier 124 including, but not limited to, a personal digital assistant (PDA), a cell phone, a cell phone with short message servicing (SMS) capabilities, a networked computer, and the like. Thus, customer identification device 108 may also connect to a network and can transmit and receive transactions. Furthermore, in some embodiments, the customer herself 102 does not have to present a customer identification device 108 but may be able relay the customer change account identifier 124 information verbally or in writing whether in person, over the phone, via facsimile, and the like. Generally, the customer identification device 108 serves to somehow make the merchant payment system 106 aware of the customer change account identifier 124 information so that change server 110 can credit the customer's change account 114 with the correct amount of change.

Merchant payment system 106 can be any transaction device that assists a merchant in performing an electronic refund of change and can be used to make a request for a change settlement. In addition, merchant payment system 106 can be any device that is able to identify the merchant change account identifier 117 including, but not limited to, a personal digital assistant (PDA), a cell phone, a cell phone with short message servicing (SMS) capabilities, a networked computer, a point of sale terminal, or an automatic teller machine, and the like. Thus, merchant payment system 106 may also connect to a network and can transmit and receive transactions. In general, the merchant payment system 106 has an input component that accesses transaction data as described herein, and a networking component, which transmits transaction requests over a network.

Where customer identification device 108 or merchant payment system 106 are able to connect to a network, the network may be any type of electronic network. Suitable networks include a Global System for Mobile communications (GSM) network, including General Packet Radio Service (GPRS) and Enhanced Data rate for GSM Evolution (EDGE) services, other cell phone networks such as a Code Division Multiple Access (CDMA) network, a public switched telephone network, or the Internet.

In one embodiment, customer identification device 108 can be an integrally formed device. For example, the device 108 could be a card, financial card, a Subscriber Information Module (SIM) card, a smart card, infrared (IR) card, or a radio frequency (RF) card, wherein the storage device 122 is an integrally formed magnetic strip, SIM circuit, smart chip, RF circuit, IR circuit, and the like, and the customer information 116 is encoded on the storage device 122.

In other embodiments, storage devices 120, 122 can be discretely formed from customer identification device 108 and/or merchant payment system 106 and have customer information 116 or merchant change account identifier 117, respectively, encoded thereon. Merchant payment system 106 and/or customer identification device 108 are configured to operate when storage devices 120, 122, respectively, are engaged in corresponding slots in the device(s). For instance, a cell phone on a GSM network can use the SIM card when inserted into a slot in the cell phone having a SIM card reader. A point of sale terminal or an ATM may use the financial card, or the smart card. The point of sale terminal may have a card swiper that reads the magnetic stripe on the back of the card. The PDA may have a wireless card reader that accepts credit cards and/or smart cards and communicates with the PDA over a specified radio frequency. The PDA may also have a click and point interface or an infrared interface. Generally, any connection means can be used to connect storage devices 120, 122 with customer identification device 108 as circumstances require.

Thus, storage device 120 has merchant change account identifier 117 thereon while storage device 122 has the customer change account identifier 124 stored thereon. Merchant change account identifier 117 and change account identifier 124 can be any unique alphanumeric or binary code that can be used to identify customer 102 or merchant 104. Identifying information can include, but is not limited to, a SIM ID number, a telephone number, a name, or a uniquely assigned name or number. Merchant change account identifier 117 and change account identifier 124 may be encoded on the storage devices 120, 122 for the purpose of conducting financial transactions. The storage devices 120, 122 may be selectively inserted into a corresponding merchant payment system 106 or customer identification device 108 in order for the device to facilitate a financial transaction using the specific merchant change account identifier 117 and/or change account identifier 124.

In one embodiment, the customer change account identifier 124 can be a unique identifier specific to the corresponding customer change account 114. However, the database 112 on change server 110 can associate the customer change account 114 with a unique number or ID that is placed on customer identification device 108 for other purposes. For example, the customer change account identifier 124 on a SIM card is a SIM ID number that is used to keep track of a telephone account that the customer has with a cell phone provider. Although the SIM number has this independent use, the same SIM ID number can be used to associate change account 114 with electronic financial transactions associated with customer identification device 108.

Customer 102 and merchant 104 can provide the customer change account identifier 124 and merchant change account identifier 117 in several different ways depending on the type of customer identification device 108 and/or merchant payment system 106 being used. The customer change account identifying 124 can be relayed verbally, in writing, via facsimile, and the like. The customer change account identifier 124 can also be provided from storage device 120 using any of the technologies described herein or that would be understood to those of skill in the art. For instance, customer 102 may swipe the customer identification device 108 in a swiper for merchant payment system 106 to read a magnetically coded strip, insert the customer identification device 108 into a slot for merchant payment system 106 to read a smart chip, place the customer identification device 108 in front of an IR scanner, or place the customer identification device 108 within range of an RF scanner. In yet another embodiment, the customer identification device may send a Short Messaging Service (SMS) message to change server 110 to initialize the change account 114. Upon receiving the SMS message, change server 110 detects the SIM ID number and associates it with customer's change account 114.

With reference to FIG. 2, an exemplary change settlement process will now be described. At 200, the customer 102 presents an item for purchase at the merchant payment system 106. Where the item is physically contained at the merchant payment system 106, for example a vending machine, the customer 102 may select an item for purchase.

At 202, a cashier registers the item for purchase to identify an amount due for purchase of the item. The merchant payment system 106 may optionally display the amount due. At 204, customer 102 presents currency for payment of the item. At 206, the cashier accepts the currency and enters the amount into the merchant payment system 106. In the case of, for example, a vending machine, the currency is accepted into the merchant payment system 106.

At 208, merchant payment system 106 calculates the amount of change due to the customer from the purchase transaction. Of course, the amount of change due may also be displayed on merchant payment system 106. When a positive amount of change is due, at 210, the customer presents a customer identification device 108 containing the customer change account identifier 124. At 212, the merchant payment system 106 includes means for accepting the customer change account identifier 124 into the payment system. In embodiments where the change server 110 is electronically connected to merchant payment system 106, for example, in a network configuration, merchant payment system 106 can automatically provide a prompt for entering the customer change account identifier 124.

As will be appreciated, since the exact configuration of the merchant payment system 106 is not essential, the merchant payment system 106 can accept customer change account identifier 124 in any of various ways. For instance, merchant payment system 106 may have a keypad by which data, such as a monetary amount for the change transaction, can be keyed in. The keypad can also be used to key in customer change account identifier 124. Alternatively, merchant payment system 106 may have an external device that encodes the change transaction data 152 and prepares it for transmission over the network. The external device may be a card reader and/or may be wireless. In one embodiment, the external device includes a Bluetooth wireless device. In another embodiment, the merchant payment system 106 may have an IR or RF scanner detecting device and the customer can hold the customer identification device 108 under the IR or RF scanner the customer change account identifier 124 into the merchant payment system 106. Furthermore, a card reader such as a card swiper may be incorporated directly on to merchant payment system 106.

As shown in FIG. 1C, merchant payment system 106 transmits a change transaction request 150 to change server 110. The change transaction request 150 can include transaction data 152 and merchant change account identifier 117. Transaction data 152 includes information used to execute the requested financial transaction, such as the customer change account identifier 124. Transaction data 152 also includes the amount of change to be transferred from merchant change account 115 to customer change account 114. Receipt of the transaction data by change server 110 serves as a request by the merchant payment system 106 to perform a settlement exchange to load the change onto the customer change account 114.

At 214, the change server 110 receives the request from the merchant payment system 106 and initiates settlement of the change transaction submitted by the merchant 104. The merchant payment system 106 communicates with change server 110 and may request an authorization from the customer 102 and/or the merchant 104 to access the customer change account 114 and/or the merchant change account 115. Assuming proper authorization is met, the change server 110 completes the change transaction.

In one embodiment, completion of the change transaction involves the change server 110 accessing the accounts in database 112 and comparing merchant change account identifier 117 received in the change transaction request with merchant change account identifier 117 associated with merchant change account 115. Where the transaction data also includes other information retrieved from customer identification device 108 such as, but not limited to, customer change account identifier 124, a unique serial number 126, customer information 128, balance 130 for customer change account 114, and/or previous transaction information 132, the change server 110 may also use any of this information to identify the correct customer change account 114 in database 112. If the merchant change account identifier 117 matches, change server 110 debits the amount owed to the customer change account 114. It will be appreciated that settlement fees may be charged to either the customer 102 or merchant 104 and so the amount credited to the customer change account 114 or debited from the merchant change account 115 will be decreased and/or increased depending on which party assumes the transaction fees.

At 216, merchant payment system 106 receives a response from change server 110 as to whether or not the change transaction request has been approved and/or completed. Confirmation may be displayed on merchant payment system 106.

At 218, in one embodiment, the customer identification device 108 is recoded to contain an updated balance 130 and/or transaction 132 to reflect the current deposit. This can include placing customer identification device 108 in communication with merchant payment system 106 a second time to transfer the credit electronically thereto. Thus, the merchant payment system 106 can include a swiper to read and/or write to a card with a magnetic strip, a smart card reader/writer, an IR or RF scanner to transmit information to a customer identification device 108, or the like. It will be appreciated that the deposit of change could be directly loaded onto customer identification device 108 and that the customer change account 114 may be eliminated. However, having customer change account 114 containing a record of the balance and transactions of the customer can provide a way to verify funds in case the customer identification device 108 becomes misplaced or broken.

Change settlements are preferably handled at the time of purchase. Alternatively, merchant payment system 106 can save up change requests and periodically send them to change server 110.

Change transactions credited to the customer change account 114 are added to an available balance of change. In embodiments where the merchant change account 115 and customer change account 114 are maintained with the same entity, such as the same change server 110, the funds can be made available to the customer 102 as soon as the change transaction is authorized. This eliminates the need to wait until the change transaction has settled because the transfer of funds can occur within the same financial entity without requiring settlement of change transactions by outside entities.

In view of the foregoing, the present invention provides benefits to both customers and merchants. Merchants will view this invention as a feature to attract potential customers. The merchant also benefits because the cashier does not have to manually count out change, the process of which can result in error. Further, the merchant is more efficient because change transactions are handled electronically, which reduces the wait time for sales lines. In addition, the present invention minimizes handling and overheads of managing coin transactions. Thus, the merchant should experience increased customer satisfaction.

For customers, the wait to time to receive change is drastically reduced. Further, the change is received in electronic format so that the only thing the customer needs to carry is the customer identification device 108. Where the customer identification device 108 is used for various functions in addition to receiving change, such as a cell phone, credit card, debit card, and the like, existing devices that customers already are accustomed to carrying can easily be modified to create a customer identification device 108, as will be described further below.

Another benefit to customers is the ability to utilize change in an effective way—by aggregating change credits to electronic form which can easily be used or cashed. Thus, in one embodiment, the balance of the customer change account 114 is linked with the customer identification device 108. This allows the customer to immediately access the balance in the customer change account 114 for subsequent purchases or payments. Enabling a customer 102 to further access the balance in the customer change account 114 eliminates the need to transfer the balance in customer change account 114 to another financial account. Thus, in one embodiment, change transactions loaded onto the customer change account 114 can accumulate unless or until reduced by transaction fees, access charges, service charges, or debit transactions, or the like. Because the authorized funds are immediately available on customer identification device 108, the customer 102 can use the device, for example, at an ATM (Automatic Teller Machine) to withdraw cash using an encrypted personal identification number (PIN). In other embodiments, the change balance can accrue in forms other than electronic funds such as, but not limited to, reward points, rebate transactions, and the like.

In other embodiments, funds in the customer change account 114 can be transferred to other change accounts held by the customer in the same or a different change server 110. In still other embodiments, described below, funds in the customer change account 114 can be loaded to third party (TP) payment systems to other financial accounts held by the customer to increase the balance or be applied to a credit balance thereof.

Turning back to FIG. 1A, other embodiments of financial systems that can be used in order to implement features of the present invention are illustrated. The following description of associations, issuers, and acquirers is provided as a reference for alternative embodiments. In one embodiment, the merchant 104 and customer 102 can have access to electronic funds belonging to the merchant or customer, respectively, herein referred to as third party funds. FIG. 1A thus shows that, in some embodiments, merchant payment system 106 and customer identification device 108 can be associated with an acquirer 170 and an issuer 172, respectively. Acquirer 170 and issuer 172 can be part of an association 174. The association 174 is a business, corporation, jointly owned corporation, or other entity that administers, promotes, and markets certain brands of cards. Exemplary associations include MasterCard International, Incorporated, and Visa U.S.A., Inc. The members of the associations include both issuers and acquirers. An acquirer is a financial entity such as a bank or an agent of a bank that issues a financial account to a merchant. Further, an issuer is a financial entity such as a bank or an agent of a bank that issues a financial account to a customer. While issuer 172 and acquirer 170 are shown as separate financial entities, in one embodiment, the same financial entity can be both an issuer and acquirer.

In FIG. 1A, the acquirer 170 has issued a merchant account 176 to merchant 104. The merchant account 176 is stored in a database 178 associated with the acquirer 170. In addition, the acquirer 170 can communicate with a processor 180. Similarly, issuer 172 has issued a customer account 182 to customer 102. The customer account 182 is stored in a database 184 associated with the issuer 172 and the issuer 172 can be in communication with a processor 186. Customer account 182 can be a credit account or a debit account.

In one embodiment, both the customer financial account 182 and merchant financial account 176 can be BIN accounts. BIN accounts are typically assigned by association 174 to the issuers 172 and/or acquirers 170. When a customer initiates a purchase transaction with a merchant and the issuer 172 authorizes the transaction, the customer financial account 182 is debited by the amount of the purchase transaction. The issuer 172 is thereby responsible for the amount debited. The issuer 172 is reimbursed by the customer.

The customer financial account 182 and the merchant financial account 176 reflect the purchase transactions that occur between customers and merchants. The customer financial account 182 indicates the sum of money that the issuer 172 must pay while the merchant financial account 176 indicates the sum of money that the acquirer 170 is to receive. During clearing, funds are moved from the customer financial account 182 to the merchant financial account 176. During settlement, the available balance of customer identification device 108 is increased to reflect the funds that have been received from the issuer 172. The BIN accounts of the members of the association can be used to clear and settle funds. In embodiments where the issuer 172 and acquirer 170 are the same entity, the customer and merchant are not required to have an external settlement account.

The above has described an exemplary system for allowing a customer 102 and merchant 104 to perform electronic purchase transactions as is well known in the art. However, in accordance with the present invention, the above system can also provide the infrastructure for alternative embodiments of implementing the change process system and methods described above. Both issuer 172 and acquirer 170 an include processors 180, 186, respectively, that enables the issuer 172, acquirer 170 and/or change server 110 to communicate and exchange data relevant to the change transactions that occur between these entities.

In one embodiment, the customer identification device 108 can be tied to the customer financial account 182. As such, the customer identification device 108 could be used to electronically access the financial account 182 to access change that has been transferred to the financial account 182. The financial account 182 can serve as a checking account of the customer 102, a credit card wherein the financial account 182 is associated with a line of credit extended to the customer 102 by the issuer 172, and the like. Thus, the customer 102 can use the customer identification device 108 to perform financial transactions associated with customer financial account 182.

In these embodiments where the customer identification device 108 is tied to an external customer financial account 182, storage device 120 can be encoded with additional information such as the customer financial account identifier 134 (see FIG. 1B) as well as any other information typically associated with the customer financial account. In one embodiment, the change server 110 could be the same financial entity as issuer 172. The customer change account 114 could still be maintained separately from financial account 182. Alternatively, customer change account 114 could be the same as the financial account 182 and so the customer change account identifier 124 and customer financial account identifier 134 could be the same. In this scenario, the same entity is performing the change settlement transaction and other financial functions on behalf of the customer.

In another embodiment, where customer change account 114 and customer financial account 182 are separate, change server 110 can transfer the funds in the customer's change account 114 to customer financial account 182 to be accessed by customer using customer identification device 108 or a different access device 188. Furthermore, it will be appreciated that other entities other than the customer may have permission to access either customer financial account 182 and/or customer financial account 182. For example, when a customer decides to contribute all of their change balance stored in customer change account 114 to a charity organization, the charity organization may be able to access part or all of the change balance one or more times as the customer allows.

As shown in FIG. 1A, in some embodiments, merchant payment system 106 may route the change request through acquirer 170, so that the change server 110 receives the request to perform a change settlement from the acquirer 170 associated with the merchant instead of directly from the merchant payment system 106.

In another embodiment, the change server 110 could be the same financial entity as acquirer 170. The merchant change account 115 could still be maintained separately from financial account 182. Alternatively, customer change account 114 could be the same as the financial account 176. In this scenario, the same entity is performing the change settlement transaction and other financial functions on behalf of the merchant. Thus, while change server 110, acquirer 170 and issuer 172 are shown as potentially three separate financial entities being involved in a change transaction, it will be appreciated that as few as one financial entity for performing the change settlement and also perform other financial functions for both of the customer and merchants.

The foregoing systems and methods thus illustrate various embodiments for enabling a customer to receive change electronically. Such systems and methods can easily be applied to newly developed systems specifically designed for receiving electronic change, or can be applied to existing credit/debit systems. Further, the systems and methods can be implementing in conjunction with other programs such as travel rewards programs, charity organizations, companies utilizing payment transponder technologies (such as MobilPass and EZpass), college programs, or any other organization capable of implementing the features taught herein.

Embodiments within the scope of the present invention may be incorporated into systems. Embodiments included dedicated devices or systems that include both hardware and/or software components.

Embodiments within the scope of the present invention also include computer readable media having executable instructions or data fields stored thereon. Such computer readable media can be any available media which can be accessed by a general purpose or special purpose computer. By way of example, and not limitation, such computer readable media can comprise RAM, ROM, EEPROM, CD-ROM or other optical disk storage, magnetic disk storage or other magnetic storage devices, or any other medium which can be used to store the desired executable instructions or data fields and which can be accessed by a general purpose or special purpose computer. Combinations of the above should also be included within the scope of computer readable media. Executable instructions comprise, for example, instructions and data which cause a general purpose computer, special purpose computer, or special purpose processing device to perform a certain function or group of functions.

Although not required, the invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor-based or programmable customer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a system for performing purchase transactions between a customer and a merchant, a method for refunding change electronically to the customer when the customer presents more currency than is needed to purchase one or more items, the method comprising:
presenting one or more items for purchase;
presenting currency for payment of the one or more items to cover a purchase price for the one or more items;
presenting a customer identification device in response to identification of change that is due; and
receiving at least a portion of the change electronically on the customer identification device using customer information located on the customer identification device.

2. The method as recited in claim 1, wherein receiving at least a portion of the change electronically on the customer identification device further comprises sending the customer information to a change server, the change server including a database holding a customer change account identifiable using the customer information.

3. The method as recited in claim 1, wherein the customer information comprises one or more of a customer change account identifier, a unique serial number, customer identification information, a balance for a customer change account, or previous transaction information.

4. The method as recited in claim 1, wherein presenting a customer identification device comprises one or more of:
the customer identification device being a card with a magnetically encoded strip and swiping the card on a swiper of a merchant payment system;
the customer identification device being a smart card with a smart chip and inserting the smart card in a slot of a merchant payment system;
the customer identification device being an IR enabled card and placing the IR enabled card in front of an IR scanner of a merchant payment system;
the customer identification device being an RFID enabled card and placing the RFID enabled card in front of an RF scanner of a merchant payment system; or
the customer identification device being a networked device and initiating sending of a message including the customer information over a network of a merchant payment system.

5. The method as recited in claim 1, wherein presenting a customer identification device comprises one or more of:
presenting the customer information verbally;
presenting the customer information in writing;
presenting the customer information via telephone; and
presenting the customer information via facsimile.

6. The method as recited in claim 2, wherein the customer change account identifier includes one or more of a SIM ID number, a telephone number, a name, or a uniquely assigned alphanumeric sequence.

7. The method as recited in claim 1, further comprising accessing a balance in a customer change account, the balance including the at least a portion of the change.

8. The method as recited in claim 7, further comprising transferring the balance of the customer change account to a third party payment system.

9. In a system for performing purchase transactions between a customer and a merchant, a method for refunding change electronically to the customer when the customer presents more currency than is needed to purchase one or more items, the method comprising:
identifying one or more items for purchase;
calculating a purchase price for the one or more items;
receiving currency for payment of the one or more items;
identifying whether the currency exceeds the purchase price for the one or more items indicating that change is due;
identifying a customer identification device; and
refunding at least a portion of the change electronically on the customer identification device using customer information located on the customer identification device.

10. The method as recited in claim 9, wherein refunding at least a portion of the change electronically on the customer identification device further comprises sending a merchant change account identifier to a change server, the change server including a database holding a merchant change account identifiable using the merchant change account identifier.

11. The method as recited in claim 9, wherein the customer information comprises one or more of a customer change account identifier, a unique serial number, customer identification information, a balance for a customer change account, or previous transaction information.

12. The method as recited in claim 9, wherein identifying a customer identification device comprises one or more of:
the customer identification device being a card with a magnetically encoded strip and receiving the card on a swiper of a merchant payment system;
the customer identification device being a smart card with a smart chip and receiving the smart card in a slot of a merchant payment system;
the customer identification device being an IR enabled card and detecting the IR enabled card by an IR scanner of a merchant payment system;
the customer identification device being an RFID enabled card and detecting the RFID enabled card by an RF scanner of a merchant payment system; or the customer identification device being a networked device and receiving a message including the customer information over a network of a merchant payment system.

13. The method as recited in claim 9, wherein identifying a customer identification device comprises one or more of:
receiving the customer information verbally;
receiving the customer information in writing;
receiving the customer information via telephone; and
receiving the customer information via facsimile.

14. The method as recited in claim 11, wherein the customer change account identifier can be one or more of a SIM ID number, a telephone number, a name, or a uniquely assigned alphanumeric sequence.

15. In a system for performing purchase transactions between a customer and a merchant, a method for refunding change electronically to the customer when the customer presents more currency than is needed to purchase one or more items, the method comprising:
receiving a change transaction request from a merchant payment system, the change transaction request including transaction data having customer information, an amount of change to be transferred, and a merchant change account identifier; and
transferring at least a portion of the amount of change from a merchant change account to a balance of a customer change account.

16. The method as recited in claim 15, further receiving an authorization from the merchant payment system in response to an authorization prompt.

17. The method as recited in claim 15, wherein the customer information includes one or more of a customer change account identifier, a unique serial number, a balance for the customer change account, or previous transaction information,

18. The method as recited in claim 15, further comprising subtracting settlement fees from the amount of change to be transferred.

19. The method as recited in claim 15, further comprising making the balance of the customer change account immediately available for access by a customer.

20. The method as recited in claim 15, further comprising transferring the balance of the customer change account to a third party payment system.
